(19) United States
(12) Patent Application Publication
(10) Pub. No.: US 2010/0097173 A1
(43) Pub. Date: Apr. 22, 2010

(54) Entry/Exit Managing Device and Information Communication Terminal

(75) Inventors: Taro ISHIGE, Matsumoto-shi (JP); Akihito FUKAO, Chino-shi (JP); Yusuke TAKAHASHI, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/603,398

(22) Filed: Oct. 21, 2009

(30) Foreign Application Priority Data
Oct. 21, 2008 (JP) 2008-271391

(51) Int. Cl. G05B 19/00

(52) U.S. Cl. 340/5.6; 358/1.14

(57) ABSTRACT

An entry/exit managing device for controlling entry and exit of a user, who carries a portable memory and an information communication terminal, to and from a predetermined place includes: a portable memory communication unit which reads and writes data from and to the portable memory; a user managing unit which executes user authentication on the basis of user information stored in the portable memory; and a network device use information managing unit which manages network device use information used to set a network device use setting parameter in the information communication terminal. The portable memory communication unit reads the user information from the portable memory when the user enters the predetermined place. The user managing unit executes the user authentication on the basis of the user information. The portable memory communication unit writes the network device use information in the portable memory, when the user authentication succeeds.

### CROSS-REFERENCE TO RELATED APPLICATIONS

This application claims the benefit of priority under 35 USC 119 of Japanese application no. 2008-271391, filed on Oct. 21, 2008, which is incorporated herein by reference.

### BACKGROUND

1. Technical Field

The present invention relates to an entry/exit managing device and an information communication terminal capable of easily setting the use of a network device in accordance with the place of use in the information communication terminal such as a portable personal computer.

2. Related Art

In recent years, information communication terminals such as personal computers have come into wide use as mobile devices. Therefore, users increasingly use the information communication terminals, while frequently moving from place to place. With this tendency, JP-A-2006-323562 discloses a system for setting information communication terminals based on an installation place or generating information to be supplied.

According to the system disclosed in JP-A-2006-323562, the information communication terminals can be set appropriately in accordance with places. However, information on a server address used to acquire setting data, information on network used to communicate with the server, and so forth have to be set in advance in the information communication terminals. In addition, “a place code label” supplied as a barcode, for example, has to be read. Therefore, when a user forgets to operate the reading, appropriate settings cannot be executed.

### SUMMARY

An advantage of some aspects of the invention is that it provides an information communication terminal capable of further permitting a user to more easily execute network device use settings suitable for a use place.

According to an aspect of the invention, there is provided an entry/exit managing device for controlling entry and exit of a user, who carries a portable memory and an information communication terminal communicable with each other, to and from a predetermined place. The entry/exit managing device includes: a portable memory communication unit which reads and writes data from and to the portable memory; a user managing unit which executes user authentication to determine whether the user is permitted to enter the predetermined place on the basis of user information stored in advance in the portable memory; and a network device use information managing unit which manages network device use information used to set a network device use setting parameter in the information communication terminal, the network device use setting parameter being necessary to use a predetermined device usable in the predetermined place and being dependent on an attribute of the predetermined network device. The portable memory communication unit reads the user information from the portable memory when the user enters the predetermined place. The user managing unit executes the user authentication on the basis of the user information read from the portable memory by the portable memory communication unit. The portable memory communication unit writes the network device use information managed by the network device use information managing unit in the portable memory, when the user authentication of the user managing unit succeeds.

With such a configuration, when the user enters the predetermined place, the network device use information is automatically written in the portable memory (for example, an IC card having a wireless communication function) of the user. Thereafter, the user can easily input the network device use information from the portable memory to the information communication terminal by using a communication function between the portable memory and the information communication terminal. In the information communication terminal, the setting parameters (the network device use setting parameters) (for example, a printer driver name, a network address, and a printer name of a network printer) dependent on the attribute of a predetermined network device (for example, the network printer installed in the place) usable in the predetermined place are set on the basis of the input network device use information. Accordingly, when the user carries the information communication terminal at a certain place, it is simpler for the user to execute an operation of additionally changing the network setting or the network device use setting in the information communication terminal in accordance with a network device use environment of the place.

The entry/exit managing device having the configuration may further include a network information managing unit which manages network information used to set a network setting parameter in the information communication terminal, the network setting parameter being used to connect to a predetermined network in the predetermined place and being dependent on the attribute of the predetermined network. The portable memory communication unit writes the network information managed by the network information managing unit in the portable memory, when the user authentication of the user managing unit succeeds.

With such a configuration, when the information communication terminal is set so that the network device is usable in the predetermined place, the network setting parameters (for example, a host name, a network address of a gateway, a network address allocated to the information communication terminal, etc.) dependent on the attribute of the network at the place are required to be set in the information communication terminal, as well as the network device use setting parameters dependent on the attribute of the network device. According to the above configuration, the network information used to set the network setting parameters as well as the network device use information used to set the network device use setting parameters is automatically written in the portable memory of the user. Accordingly, when the user carries the information communication terminal to a certain place, it is simpler for the user to execute an operation of additionally changing the network setting or the network device use setting in the information communication terminal in accordance with a network device use environment of the place.

In the entry/exit managing device having the above-described configuration, the network device use information written in the portable memory from the portable memory communication unit may contain the network device use setting parameter.

With such a configuration, the network device use setting parameters to be set in the information communication terminal are written in the portable memory of the user. Therefore, a work for setting the network device use setting in the information communication terminal can be executed actually only with the function of the entry/exit managing device (that is, even though the information communication terminal has no specific setting function). Accordingly, it is simpler for the user to execute an operation of additionally changing the setting of the information communication terminal in accordance with an environment of the place which the user enters.

In the entry/exit managing device having the above-described configuration, the network device use information written in the portable memory from the portable memory communication unit may contain a URL indicating the location of the network device use setting parameter.

With such a configuration, the information communication terminal can acquire and set the network device use setting parameters by using the URL (for example, a URL of a server computer for supplying the network device use setting parameters) input from the portable memory. The management of the network device use setting parameters which may be changed in future in accordance with different places can be collectively executed with the URL (for example, the server computer). For example, a certain network device may be removed from a certain place or a new network device may be installed in the place. Even in this case, when the network device use setting parameters managed with the URL associated with the place are updated, the same URL continues to be effective in future. Therefore, the user can use the URL input to the portable memory or the information communication terminal in future. Accordingly, it is simpler for the user to execute the operation of additionally changing the setting of the information communication terminal in accordance with an environment of the place which the user has entered.

According to another aspect of the invention, there is provided an information communication terminal including: a network device using unit which gains access to an arbitrary network using a network setting parameter dependent on a preset attribute of the arbitrary network and a network device use setting parameter dependent on an attribute of an arbitrary network device and which uses the arbitrary network device; a portable memory reading unit which reads data from a portable memory carried by a user; and a network device use setting unit which inputs network device use information, which is used to set a network device use setting parameter dependent on an attribute of a certain network device in the network device using unit, from the portable memory using the portable memory reading unit, acquires or generates the network device use setting parameter on the basis of the input network device use information, and sets the acquired or generated network device use setting parameter in the network device using unit, when the network device use information is stored in the portable memory.

With such a configuration, it is possible to automatically set the network device use setting parameter necessary to use a specific network device on the basis of the network device use information which is written in advance in the portable memory. Therefore, when the network device use information associated with the network device usable in the place which the user has entered is written in advance in the portable memory, it is simpler for the user to execute an operation of additionally changing the network setting or the network device use setting in the information communication terminal in accordance with a network device use environment of the place in a case where the user carries the information communication terminal in a certain place. In particular, when the information communication terminal is used in combination with the entry/exit managing device according to the aspect of the invention, the convenience is further improved.

The information communication terminal having the configuration may further include a network setting unit which inputs network information, which is used to set a network setting parameter dependent on an attribute of a certain network in the network device using unit, from the portable memory using the portable memory reading unit, acquires or generates the network setting parameter on the basis of the input network information, and sets the acquired or generated network setting parameter in the network device using unit, when the network information is stored in the portable memory. When the network device use information and the network information are input from the portable memory, the network setting unit sets the network setting parameter on the basis of the network information, and then the network device use setting unit sets the network device use setting parameter on the basis of the network device use information.

With such a configuration, it is possible to automatically set the network setting parameter as well as the network device use setting parameters. Accordingly, it is simpler for the user to execute the operation of additionally changing the network setting or the network device use setting in the information communication terminal in accordance with a network device use environment of the place. In particular, when the information communication terminal is used in combination with the entry/exit managing device according to the aspect of the invention, the convenience is further improved.

The information communication terminal having the configuration may further include a warning unit which outputs a warning to the user, when a request is input to use a network device different from a network device specified by the network device use setting parameter which is set on the basis of the network device use information read from the portable memory.

With such a configuration, when the user wants to continue to use the information communication terminal at different places while frequently moving, it is possible to prevent the user from erroneously use the network device set at a place different from the present place (for example, when the user erroneously use a printer installed at the different place, the user cannot acquire a print) by a warning message. Accordingly, it is simpler for the user to execute the operation of additionally changing the network setting or the network device use setting in accordance with a network device use environment of the place.

The information communication terminal having the configuration may further include a network device use setting exclusion unit which nullifies a preset network device use setting parameter, when the network device use setting parameter is set on the basis of the network device use information read from the portable memory.

With such a configuration, it is possible to further prevent the erroneous use of the network device set at the place different from the present place of the user.

The information communication terminal having the configuration may further include a network setting exclusion unit which nullifies a preset network setting parameter, when the network setting parameter is set on the basis of the network information read from the portable memory.

With such a configuration, it is possible to automatically prevent the user from erroneously using network setting of the place different from the present place (the connection to the network cannot be made). Accordingly, it is simpler for the user to execute the operation of additionally changing the network setting or the network device use setting in the information communication terminal in accordance with a network device use environment of the place.

With such a configuration, since the network device use setting or the network setting executed at a certain place or information on a room can be prevented from leaking outside of the place, security is improved. In addition, there is only a low possibility that the user erroneously uses the network device of the previous place at a different place. Accordingly, it is simpler for the user to execute the operation of additionally changing the network setting or the network device use setting in accordance with a network device use environment of the place.

The information communication terminal having the configuration may further include a setting deletion unit which deletes the set network device use setting parameter and/or the set network setting parameter in response to a predetermined event occurring subsequently, when the network device use setting parameter and/or network setting parameter are set on the basis of the network device use information and/or the network information read is from the portable memory.

The predetermined event may include:

A. an event where the portable memory reading unit cannot read data of the portable memory;

B. an event where the user logs out from the information communication terminal; and

C. an event where the portable memory reading unit reads another network device use information and/or another network information from the portable memory.

With such a configuration, the unnecessary setting parameter can be appropriately deleted and only the necessary setting parameters can be collected in the information communication terminal. Therefore, since a risk that the user erroneously leaks information to the outside upon using the network device can be reduced, security can be improved. Moreover, since the user easily selects the network device to be used upon using the network, it is simpler for the user to execute the operation of additionally changing the network setting or the network device use setting in accordance with a network device use environment of the place.

In the information communication terminal having the configuration, the setting deletion unit may delete the set network device use setting parameter and/or the set network setting parameter, after the predetermined event occurs and then a predetermined period of time elapses.

With such a configuration, in a case where the predetermined event occurs due to the operation failure of the user (for example, the user logged out by mistake), the operation can be cancelled by the setting of a predetermined period of time before the deletion of the setting. Accordingly, the above-described convenience is improved for the user.

According to the entry/exit managing device according to the aspects of the invention, when the user carries the information communication terminal to a certain place, it is simpler for the user to execute the operation of additionally changing the network setting or the network device use setting in the information communication terminal in accordance with the network device use environment of the place.

### BRIEF DESCRIPTION OF THE DRAWINGS

The invention will be described with reference to the accompanying drawings, wherein like numbers reference like elements.

FIG. 1 is a diagram illustrating the configuration of a network system in which an information communication terminal and entry/exit managing devices are connected to each other according to an embodiment of the invention.

FIG. 2 is a block diagram illustrating the functional configuration of the respective devices included in the network system of FIG. 1.

FIG. 3 is a diagram illustrating an example of a card writing information.

FIG. 4 is a flowchart illustrating an entry processing sequence executed by the entry/exit managing device in FIG. 2.

FIG. 5 is a flowchart illustrating an exit processing sequence executed by the entry/exit managing device in FIG. 2.

FIG. 6 is a flowchart illustrating a log-in processing sequence executed by the information communication terminal in FIG. 2.

FIG. 7 is a flowchart illustrating a log-out processing sequence executed by the information communication terminal in FIG. 2.

FIG. 8 is a flowchart illustrating a print processing sequence executed by the information communication terminal and the network device (printer) in FIG. 2.

FIG. 9 is a diagram illustrating a warning example displayed by a warning unit in FIG. 2.

FIG. 10 is a diagram illustrating an example of a network device (printer) use setting parameters.

### DESCRIPTION OF EXEMPLARY EMBODIMENTS

Hereinafter, an embodiment of the invention will be described with reference to the drawings.

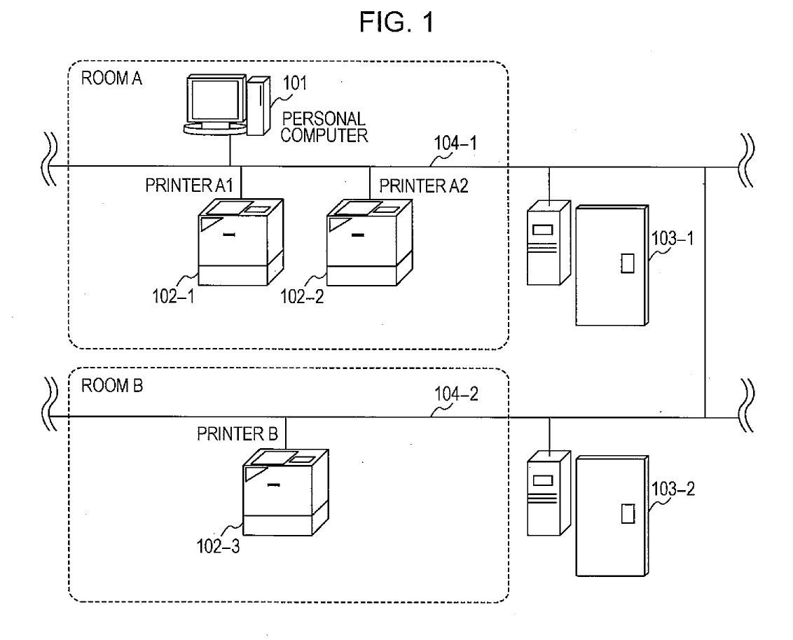

FIG. 1 is a diagram illustrating the configuration of a network system in which an information communication terminal and entry/exit managing devices are connected to each other according to the embodiment of the invention.

The network system includes at least one information communication terminal 101 (or a portable terminal capable of movement between different places) disposed at a certain place out of a plurality of different places, one or more network devices 102 (generally, a plurality of network devices disposed at the different places), one or more entry/exit managing devices 103 (generally, a plurality of entry/exit managing devices disposed at the different places), and one or more networks 104 (generally, a plurality of networks connected to various devices installed and present at the different places).

In a specific example illustrated in FIG. 1, a first network device 102-1 (for example, a network printer A1) and a second network device 102-2 (for example, a network printer A2) are disposed at a first place (for example, a room A). A first entry/exit managing device 103-1 is disposed in the vicinity of the entrance of the first place. The devices 102-1, 102-2, and 103-1 are connected to a first network 104-1 installed at the first place. A third network device 102-3 (for example, a network printer B) is disposed at a second place (for example, another room B). A second entry/exit managing device 103-2 is disposed in the vicinity of the entrance of the second place. The devices 102-3 and 103-2 are connected to a second network 104-2 installed at the second place. The first network 104-1 is connected to the second network 104-2. In addition, one information terminal 101 (for example, a personal computer) is disposed at the first place to be connected to the first network 104-1 or can be carried by a user and moved to either the first place or the second place to be connected to the network of the moved place (in the example illustrated in the drawing, the first network 104-1 at the first place).

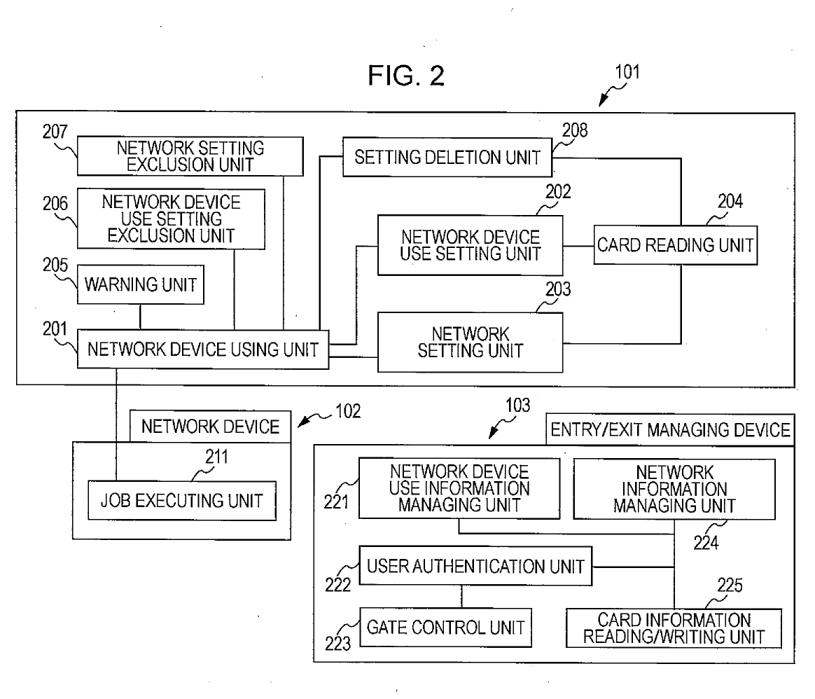

FIG. 2 is a block diagram illustrating the functional configuration of the respective devices included in the network system of FIG. 1.

The information communication terminal 101 includes a network device using unit 201, a network device use setting unit 202, a network setting unit 203, a card reading unit 204, a warning unit 205, a network device use setting exclusion unit 206, a network setting exclusion unit 207, and a setting deletion unit 208.

The network device 102 includes a job executing unit 211 for executing a job (for example, a printing job) issued from the information communication terminal 101.

The entry/exit managing device 103 includes a network device use information managing unit 221, a user authentication unit 222, a gate control unit 223, a network information managing unit 224, and a card information reading/writing unit 225.

Next, the functions of the devices 101, 102, and 103 will be described.

The functions of the entry/exit managing device 103 will be first described.

The entry/exit managing device 103 allows the gate control unit 223 to control entry and exit of a user to and from a predetermined place. When the entry/exit managing device 103 is used, the user carries a portable memory (not shown) having a communication function. The portable memory can communicate with the entry/exit managing device 103 and also communicate with the information communication terminal 101. In the following description, an IC card is used as an example of the portable memory.

In general, the entry/exit managing device 103 is installed in the vicinity of the entrance of a predetermined place such as a building or a room. When the user enters or exits the predetermined place, data (in this embodiment, referred to as a user ID, for example), which is stored in the IC card carried by the user and represents an attribute of the user, is read by the card information reading/writing unit (a portable memory communication unit) 225 and individual authentication of the user is executed by the user authentication unit (a user managing unit) 222. The entry/exit managing device 103 allows the gate control unit 223 to open a gate to permit the entry or exit of the user, only when the individual authentication succeeds. In this way, confidential information is prevented from leaking out.

In this embodiment, as well as the function of controlling the entry and exit of the user, the entry/exit managing device 103 has a function of writing information, which is used to execute network device use setting suitable for a place of use in the information communication terminal 101, in the IC card of the user, when the user is permitted to enter the place.

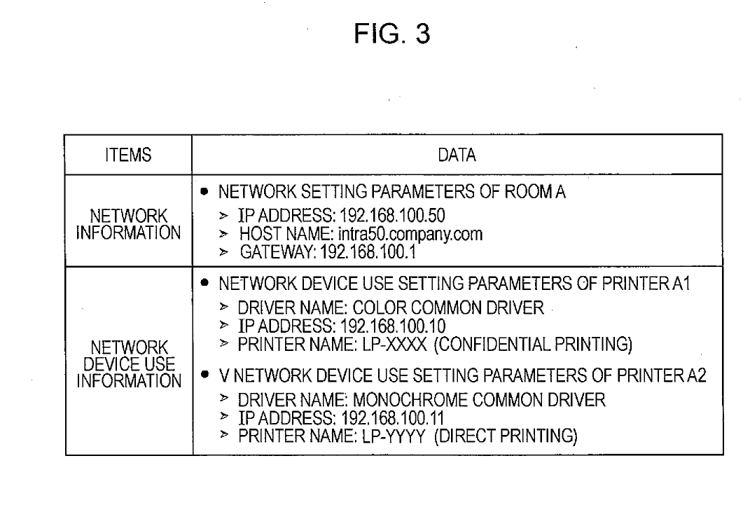

That is, when the user sets the IC card and the user authentication succeeds in the card information reading/writing unit 225 of the entry/exit managing device 103, information shown in FIG. 3 is written in the IC card by the card information reading/writing unit 225.

As shown in FIG. 3, items of the information written in the IC card includes two items, that is, network information and network information use information.

The network information is information used to set network setting parameters (for example, an IP address and a host name of the information communication terminal 101, an IP address of a gateway of the network, etc.), which are used to connect with a predetermined network at a predetermined place such as the first network 104-1 at the first place or the second network 104-2 at the second place in FIG. 1 and are dependent on an attribute of the network 104-1 or 104-2, in the information communication terminal 101.

The network information is managed by the network information managing unit 224 of the entry/exit managing device 103. In this embodiment, the network information is the network setting parameters, as exemplified in FIG. 3. However, the network information may not be the network setting parameters, but may be information permitting the network setting parameters to be set in the information communication terminal 101. For example, the network information may be a URL indicating the location of the network setting parameters or a computer program operating the information communication terminal 101 so as to set the network setting parameters in the information communication terminal 101.

The network device use information is information used to set network device use setting parameters (for example, a device driver name of a device (the printer in the example of FIG. 3), an IP address of the device, and a device name of the device, etc.), which are used to use a predetermined network device usable at a predetermined place such as the first network device 102-1 and the second network device 102-2 at the first place or the third network device 102-3 at the second place in FIG. 1 and dependent on attributes of the respective network devices 102-1, 102-2, and 102-3, in the information communication terminal 101.

The network device use information is managed by the network device use information managing unit 221 of the entry/exit managing device 103. In this embodiment, the network device use information is the network device use setting parameters, as exemplified in FIG. 3. However, the network device use information may not be the network device use setting parameters, but may be information permitting the network device use setting parameters to be set in the information communication terminal 101. For example, the network device use information may be a URL indicating the location of the network device use setting parameters or a computer program operating the information communication terminal 101 so as to set the network device use setting parameters in the information communication terminal 101.

Next, the functions of the information communication terminal 101 will be described.

The information communication terminal 101 includes the network device using unit 201 having the functions described below. That is, the network setting parameters dependent on an attribute of the arbitrary network 104 and the network device use setting parameters dependent on an attribute of an arbitrary network device can be set in the network device using unit 201. In addition, the network device using unit 201 is connected to the arbitrary network 104 by using the network setting parameters and the network device use setting parameters preset therein, and uses the arbitrary network device 102 through the arbitrary network 104.

The card reading unit (a portable memory reading unit) 204 has a function of reading data (for example, a user ID, network information, and network device use information) from the IC card, when the IC card is set in the information communication terminal 101.

The information communication terminal 101 includes a network setting unit 203 having a function described below. That is, the network setting unit 203 inputs network information from the IC card using the card reading unit 204, when the network information is stored in the IC card set in the information communication terminal 101. The network setting unit 203 acquires or generates the network setting parameters on the basis of the input network information and sets the acquired or generated network setting parameters in the network device using unit 201.

The information communication terminal 101 includes the network device use setting unit 202 having a function described below. The network device use setting unit 202 inputs network device use information from the IC card using the card reading unit 204, when the network device use information is stored in the IC card set in the information communication terminal 101. The network device use setting unit 202 acquires or generates network device use setting parameters on the basis of the input network device use information and sets the acquired or generated network device use setting parameters in the network device using unit 201.

When the network device use information and the network information are input from the IC card, the information communication terminal 101 allows the network setting unit 203 to set the network setting parameters on the basis of the network information, and then the network device use setting unit 202 sets the network device use setting parameters on the basis of the network device use information.

The information communication terminal 101 includes the warning unit 205 having a function described below. That is, when the user inputs a request (for example, a request for issuing a printing job to a certain printer) for using a certain network device 102 in the information communication terminal 101, the warning unit 205 first determines whether the network device 102 considered as a use target by the input request is the network device 102 specified by the network device use setting parameters set on the basis of the network device use information read from the IC card. When the network device 102 considered as the user target is different from the specified network device 102, a warning is output to the user.

The information communication terminal 101 includes the network device use exclusion unit 206 having a function described below. That is, the network device use setting exclusion unit 206 nullifies preset other network device use setting parameters (for example, the preset other network device use setting parameters are erased from the network device using unit 201 and written in a predetermined storage area in the information communication terminal 101), when the network device use setting parameters are set in the network device using unit 201 on the basis of the network device use information read from the IC card.

The information communication terminal 101 includes the network setting exclusion unit 207 having a function described below. That is, the network setting exclusion unit 207 nullifies preset other network setting parameters (for example, the preset other network setting parameters are erased from the network device using unit 201 and written in a predetermined storage area in the information communication terminal 101), when the network setting parameters are set in the network device using unit 201 on the basis of the network information read from the IC card.

The information communication terminal 101 includes the setting deletion unit 208 having a function described below. That is, when the network device use setting parameters and/or the network setting parameters are set on the basis of the network device use information and/or the network information from the IC card, the setting deleting unit 208 deletes the set network device use setting parameters and/or the set network setting parameters in response to the occurrence of a predetermined event (for example, preset other network setting parameters are deleted from the network device using unit 201).

The predetermined event can include some or all of, for example:

A. an event where the card reading unit 204 cannot read data of the IC card (for example, an event where the IC card once set in the information communication terminal 101 has been detached from the information communication terminal 101);

B. an event where the user logs out from the information communication terminal 101; and

C. an event where the card reading unit 204 reads another network device use information and/or another network information from the IC card (for example, an event where the user carries the information communication terminal 101, moves from the present place to another place, and sets the IC card in the information communication terminal 101 at the place where the user has moved).

The setting deletion unit 208 may delete the set network device use setting parameters and/or the set network setting parameters immediately when the predetermined event occurs. However, as a modified example, the setting deletion unit 208 may delete the set network device use setting parameters and/or the set network setting parameters, after the predetermined event occurs and a predetermined period of time elapses.

Hereinafter, the operation of the network system in FIG. 2 will be described with reference to a flowchart.

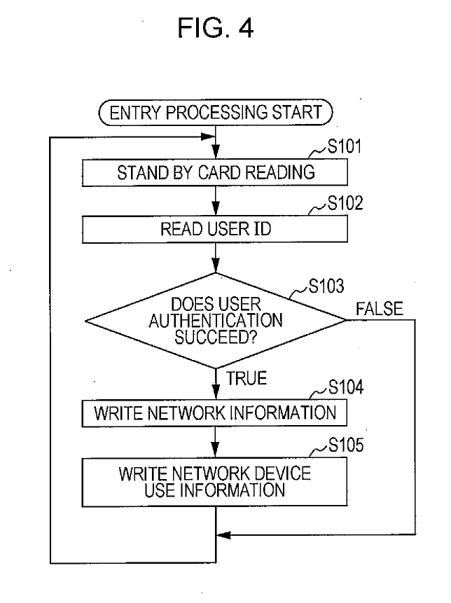

FIG. 4 is a flowchart illustrating an entry processing sequence executed by the entry/exit managing device 103 in FIG. 2.

First, after standing by card reading (S101), the card information reading/writing unit 225 reads a user ID of a user, who intends to enter a place managed by the entry/exit managing device 103, from the IC card of the user (S102).

Subsequently, the user authentication unit 222 executes the individual authentication (user authentication) of the user on the basis of the user ID to determine whether the user authentication succeed (S103). When the user authentication succeeds, the network information managing unit 224 allows the card information reading/writing unit 225 to write the network information and the network device use information, which correspond to the network 104 and the network device 102 disposed at the place (which the user intend to enter) managed by the entry/exit managing device 103, in the IC card (S104 and S105).

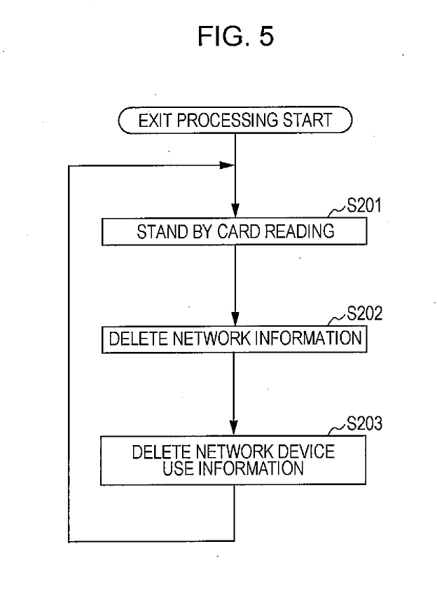

FIG. 5 is a flowchart illustrating an exit processing sequence executed by the entry/exit managing device 103 in FIG. 2.

First, after standing by card reading (S201), the network information managing unit 224 allows the card information reading/writing unit 225 to delete the network information and the network device use information (which correspond to the network 104 and the network device 102 disposed at the place) written when the user has entered the place from the IC card of the user intending to exit the place managed by the entry/exit managing device 103 (S202 and S203).

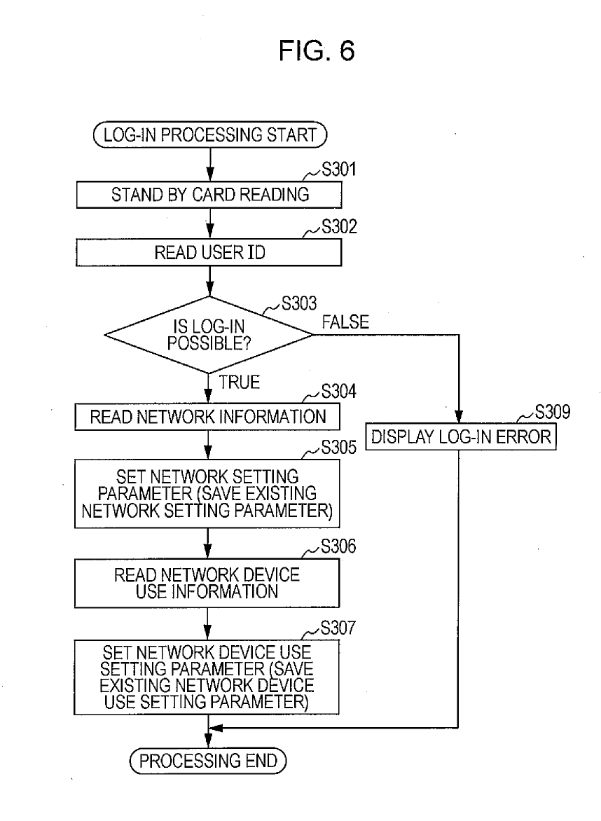

FIG. 6 is a flowchart illustrating a log-in processing sequence executed by the information communication terminal 101 in FIG. 2.

First, after standing by card reading (S301), the card reading unit 204 reads the user ID from the IC card set in the information communication terminal 101 (S302).

Subsequently, it is determined in S303 whether log-in is possible on the basis of the user ID. When it is determined that the log-in is not possible, the warning unit 205 displays a log-in error message (S309).

Alternatively, in S303, when it is determined that the log-in is possible, the network setting unit 203 reads the network information from the IC card (S304), acquires or generates the network setting parameters from the network information, and sets the network setting parameters in the network device using unit 201 (S305). In S305, when network setting parameters are set (generally, since the network device using unit 201 can set only the network setting parameters corresponding to one network), the existing network setting parameters set in the network device using unit 201 are deleted from the network device using unit 201 and written (saved) in a predetermined storage area (not shown) in the information communication terminal 101.

Subsequently, the network device use setting unit 202 reads the network device use information from the IC card (S306), acquires or generates the network device use setting parameters from the network device use information, and sets the network device use setting parameters in the network device using unit 201 (S307). In S307, when new network device use setting parameters are set (generally, since the network device using unit 201 can set the network device use setting parameters corresponding to a plurality of networks), the existing network setting parameters set in the network device using unit 201 may remain and the new network device use setting parameters may be added. Alternatively, as another method, the existing network setting parameters may be deleted from the network device using unit 201 and may be written (saved) in a predetermined storage area (not shown) in the information communication terminal 101.

In S307, the network device use setting parameters shown in FIG. 10, for example, are set in the network device using unit 201 of the information communication terminal 101. That is, when the information communication terminal 101 and the user are in the room A (the first place) show in FIG. 1, the network device use setting parameters of the printer A1 and A2 (network devices) in the room A shown in FIG. 10 are set. Alternatively, when the information terminal 101 and the user are in the room B, the network device use setting parameters of the printer B (network device) in the room B shown in FIG. 10 are set.

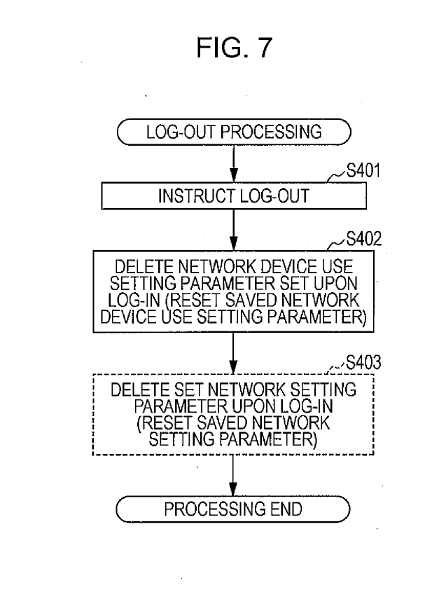

FIG. 7 is a flowchart illustrating a log-out processing sequence executed by the information communication terminal in FIG. 2.

When the log-out is instructed in S401, the setting deletion unit 208 deletes the set network device use setting parameters from the network device using unit 201 in S402 in a case where there are the network device use setting parameters set in S307 of the log-in processing in FIG. 6. In this case, when there are the network device use setting parameters saved in S307 of the log-in processing in FIG. 6, the saved network device use setting parameters may be reset in the network device using unit 201.

After S402, step S403 may be executed as follows (may not be executed). That is, in S403, the setting deletion unit 208 deletes the set network setting parameters from the network device using unit 201, when there are the network setting parameters set in S305 of the log-in processing in FIG. 6. In this case, when there are the network setting parameters saved in S305 of the log-in processing in FIG. 6, the saved network setting parameters may be reset in the network device using unit 201.

The processes described in S402 and S403 may be executed in predetermined events where it is assumed that the network device use setting parameters and/or the network setting parameters set upon the log-in instead of the log-out, as well as the log-out, are not used now. The predetermined events include, for example:

(1) an event where the card reading unit 204 cannot read the data of the IC card (for example, the IC card once set in the information communication terminal 101 is detached from the information communication terminal 101); and/or

(2) an event where the card reading unit 204 reads another network device use information and/or another network information from the IC card (for example, the user carries the information communication terminal 101, moves from the present place to another place, and sets the IC card in the information communication terminal 101 at the place where the user has moved.

In this case, the processes described in S402 and S403 may be executed immediately when the log-out is executed or the predetermined event occurs. However, as a modified example, after the log-out is executed or the predetermined event occurs and a predetermined period of time elapses, the processes described in S402 and S403 may be executed. Then, when the user erroneously executes the log-out or generates the predetermined event, it is possible to reduce the frequency at which the parameters have to be needlessly reset.

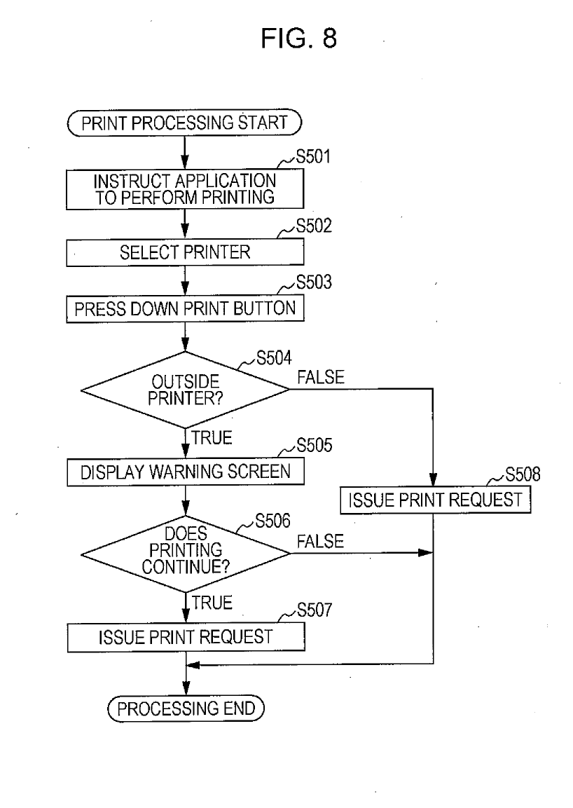

FIG. 8 is a flowchart illustrating a print processing sequence executed by the information communication terminal 101 and the network device 102 (here, referred to as a network printer, for example) in FIG. 2.

First, the information communication terminal 101 instructs its application to perform printing (S501). Then, since the network device using unit 201 displays a list of printers usable on the basis of the network device use setting parameters set therein, the user selects a desired printer (the network device 102) from the list and presses down a print button (S503).

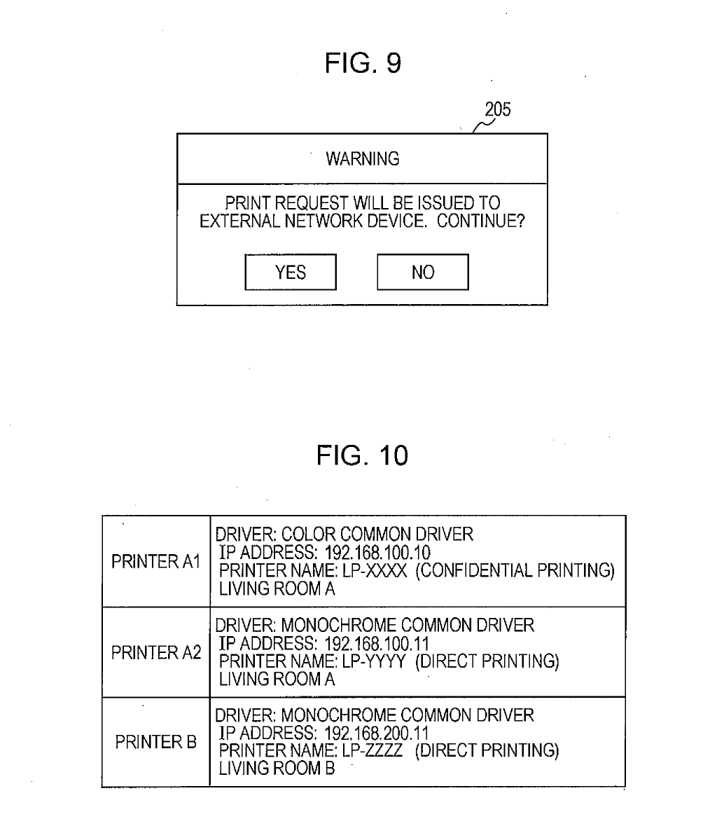

Here, the warning unit 205 determines whether the selected printer (the network device 102) is a printer (the network device 102) existing in the same place as that of the information communication terminal 101 (for example, whether IP addresses of the information communication terminal 101 and the selected printer (the network device 102) are the same domain addresses) on the basis of the network device use setting parameters of the selected printer (the network device 102) (S504). When the selected printer (the network device 102) exists outside the place of the information communication terminal 101, the warning unit 205 displays a warning which is shown in FIG. 9 (S505).

When the user selects “YES” on the warning display of FIG. 9, that is, when the user wants to continue the printing (true in S506), the network device using unit 201 communicates with the selected printer (the network device 102) using the network setting parameters set therein and the network device use setting parameters of the selected printer (the network device 102) to issue a printing job to the printer (the network device 102) (S507).

In S504, when the selected printer (the network device 102) exists at the same place as that of the information communication terminal 101, the network device using unit 201 communicates with the selected printer (the network device 102) using the network setting parameters set therein and the network device use setting parameters of the selected printer (the network device 102) to issue a printing job to the printer (the network device 102) (S508).

In the selected printer (the network device 102), the job executing unit executes the printing job.

An embodiment of the invention has been described and is just an exemplary embodiment for describing the invention. The invention is not limited to the embodiment. The invention may be modified in various forms without departing from the gist of the invention, as well as the above-described embodiment.

For example, in the above-described embodiment, the entry/exit managing device for managing the entry and exit to and from the respective places stores the network information and the network device use information suitable for the respective places. However, in a modified example, a certain server device to which a plurality of the entry/exit managing devices for managing the entry to different places can gain access may store the network information and/or the network device use information suitable for the different places to supply the network information and/or the network device use information to the respective entry/exit managing devices.

When the network information and/or the network device use information input to the information communication terminal are an URL indicating the location of the network setting parameters and/or the network device use setting parameters, the information communication terminal may receive the network setting parameters and/or the network device use setting parameters from the URL, and the network setting parameters and/or the network device use setting parameters may be set in the information communication terminal.

What is claimed is:

1. An entry/exit managing device for controlling entry and exit of a user, that carries a portable memory and an information communication terminal communicable with each other, to and from a predetermined place, the entry/exit managing device comprising:
a portable memory communication unit which reads and writes data from and to the portable memory;
a user managing unit which executes user authentication to determine whether the user is permitted to enter the predetermined place on the basis of user information stored in advance in the portable memory; and
a network device use information managing unit which manages network device use information used to set a network device use setting parameter in the information communication terminal, the network device use setting parameter being necessary to use a predetermined device usable in the predetermined place and being dependent on an attribute of the predetermined network device,
wherein the portable memory communication unit reads the user information from the portable memory when the user enters the predetermined place,
wherein the user managing unit executes the user authentication on the basis of the user information read from the portable memory by the portable memory communication unit, and
wherein the portable memory communication unit writes the network device use information managed by the network device use information managing unit in the portable memory, when the user authentication of the user managing unit succeeds.

2. The entry/exit managing device according to claim 1, further comprising:
a network information managing unit which manages network information used to set a network setting parameter in the information communication terminal, the network setting parameter being used to connect to a predetermined network in the predetermined place and being dependent on the attribute of the predetermined network,
wherein the portable memory communication unit writes the network information managed by the network information managing unit in the portable memory, when the user authentication of the user managing unit succeeds.

3. The entry/exit managing device according to claim 1, wherein the network device use information written in the portable memory from the portable memory communication unit contains the network device use setting parameter.

4. The entry/exit managing device according, to claim 1, wherein the network device use information written in the portable memory from the portable memory communication unit contains a URL indicating the location of the network device use setting parameter.

5. An information communication terminal comprising:
a network device using unit which gains access to an arbitrary network using a network setting parameter dependent on a preset attribute of the arbitrary network and a network device use setting parameter dependent on an attribute of an arbitrary network device and which uses the arbitrary network device;
a portable memory reading unit which reads data from a portable memory carried by a user; and
a network device use setting unit which inputs network device use information, which is used to set a network device use setting parameter dependent on an attribute of a certain network device in the network device using unit, from the portable memory using the portable memory reading unit, acquires or generates the network device use setting parameter on the basis of the input network device use information, and sets the acquired or generated network device use setting parameter in the network device using unit, when the network device use information is stored in the portable memory.

6. The information communication terminal according to claim 5, further comprising:
a network setting unit which inputs network information, which is used to set a network setting parameter dependent on an attribute of a certain network in the network device using unit, from the portable memory using the portable memory reading unit, acquires or generates the network setting parameter on the basis of the input network information, and sets the acquired or generated network setting parameter in the network device using unit, when the network information is stored in the portable memory,
wherein when the network device use information and the network information are input from the portable memory, the network setting unit sets the network setting parameter on the basis of the network information, and then the network device use setting unit sets the network device use setting parameter on the basis of the network device use information.

7. The information communication terminal according to claim 5, further comprising a warning unit which outputs a warning to the user, when a request is input to use a network device different from a network device specified by the network device use setting parameter which is set on the basis of the network device use information read from the portable memory.

8. The information communication terminal according to claim 5, further comprising a network device use setting exclusion unit which nullifies a preset network device use setting parameter, when the network device use setting parameter is set on the basis of the network device use information read from the portable memory.

9. The information communication terminal according to claim 6, further comprising a network setting exclusion unit which nullifies a preset network setting parameter, when the network setting parameter is set on the basis of the network information read from the portable memory.

10. The information communication terminal according to claim 5, further comprising a setting deletion unit which deletes the set network device use setting parameter and/or the set network setting parameter in response to a predetermined event occurred subsequently, when the network device use setting parameter and/or network setting parameter are set on the basis of the network device use information and/or the network information read from the portable memory.

11. The information communication terminal according to claim 10, wherein the predetermined event includes an event where the portable memory reading unit cannot read data of the portable memory.

12. The information communication terminal according to claim 10, wherein the predetermined event includes an event where the user logs out from the information communication terminal.

13. The information communication terminal according to claim 10, wherein the predetermined event includes an event where the portable memory reading unit reads another network device use information and/or another network information from the portable memory.

14. The information communication terminal according to claim 10, wherein the setting deletion unit deletes the set network device use setting parameter and/or the set network setting parameter, after the predetermined event occurs and then a predetermined period of time elapses.
